(19) United States
(12) Patent Application Publication
(10) Pub. No.: US 2015/0249886 A1
(43) Pub. Date: Sep. 3, 2015

(54) NOISE MITIGATION SEATING

(71) Applicants: James E. Haylett, Pataskala, OH (US); Andrew Polte, Marysville, OH (US)

(72) Inventors: James E. Haylett, Pataskala, OH (US); Andrew Polte, Marysville, OH (US)

(73) Assignee: CVG MANAGEMENT CORPORATION, New Albany, OH (US)

(21) Appl. No.: 14/636,914

(22) Filed: Mar. 3, 2015

Related U.S. Application Data
(60) Provisional application No. 61/947,168, filed on Mar. 3, 2014.

(51) Int. Cl. H04R 3/00

(52) U.S. Cl. CPC H04R 3/002; H04R 2499/13

(57) ABSTRACT

A noise mitigation seating system includes a listening component to detect ambient noise from the surrounding area as perceived inside a vehicle cabin. A control component analyzes the ambient noise for noise mitigation. The control component generates a noise mitigation output based on the analyzed ambient noise and a sound profile. Sound profiles describe criteria for noise mitigation. A speaker component renders the noise mitigation output to interfere with the ambient noise such that the ambient noise is reduced or canceled.

### CROSS REFERENCE TO RELATED APPLICATIONS

This application claims the benefit of U.S. Provisional Patent application Ser. No. 61/947,168 entitled “Noise Mitigation Seating” and filed Mar. 3, 2014. The entirety of the above-noted application is incorporated by reference herein.

### BACKGROUND

Sound can be referred to as a pressure wave which includes a compression phase and a rarefraction phase. In operation, a noise-cancellation speaker emits a sound wave with the same amplitude but with inverted phase or antiphase to the original sound. By combining the wave to generate an interference or new wave, the noise is mitigated by waves effectively cancelling each other out. This process is often referred to as phase cancellation.

Conventional noise control employs analog circuits as well as digital signal processing. Adaptive algorithms are designed to analyze the waveform of the background noise. Based upon the specific algorithm, a signal is generated that will either phase shift or invert the polarity of the original signal. The inverted signal (in antiphase) is then amplified and a transducer creates a sound wave that is directly proportional to the amplitude of the original waveform, creating destructive interference thereby effectively reducing the volume of the perceivable noise.

### SUMMARY

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

According to one aspect, a system that facilitates noise mitigation, comprising: at least one listening component that samples ambient noise; a control module that receives and analyzes a noise signal from the listening component and generates an output based at least in part upon the analysis; and at least one speaker component that renders the output, wherein the at least one speaker is positioned within a seating apparatus of a vehicle component.

According to another aspect, a method of mitigating noise, comprising: receiving an audio signal input of detected ambient noise; analyzing the audio signal input; generating a noise mitigating output based on the analyzed audio signal input; and rendering the noise mitigating output such that detected ambient noise is reduced.

According to yet another aspect, a computer readable medium containing instructions for controlling one or more processors configured to: detect ambient noise inside and around a vehicle cabin; convert the ambient noise into a digital audio signal; analyze the digital audio signal for noise mitigation; access a sound profile that details settings for noise mitigation based on stored criteria; generate a cancellation wave signal according to the sound profile and the analyzed digital audio signal; and play the cancellation wave signal in the vehicle cabin to interfere with the ambient noise.

One advantage resides in a noise mitigation affect perceived by the user.

Another advantage resides in noise mitigation interfacing with many aspects of operating a vehicle.

Still further advantages of the present invention will be appreciated to those of ordinary skill in the art upon reading and understanding the following detailed description.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of an example component diagram of a system for noise mitigation, according to one or more embodiments.

FIG. 2 illustrates an example seat of a system of noise mitigation in accordance with an aspect of the innovation.

FIG. 3 illustrates an example noise mitigation seating system in accordance with an aspect of the innovation.

FIG. 4 is an illustration of an example flow diagram of a method for noise mitigation, according to one or more embodiments.

FIG. 5 is an illustration of an example computer-readable medium or computer-readable device including processor-executable instructions configured to embody one or more of the provisions set forth herein, according to one or more embodiments.

FIG. 6 is an illustration of an example computing environment where one or more of the provisions set forth herein are implemented, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

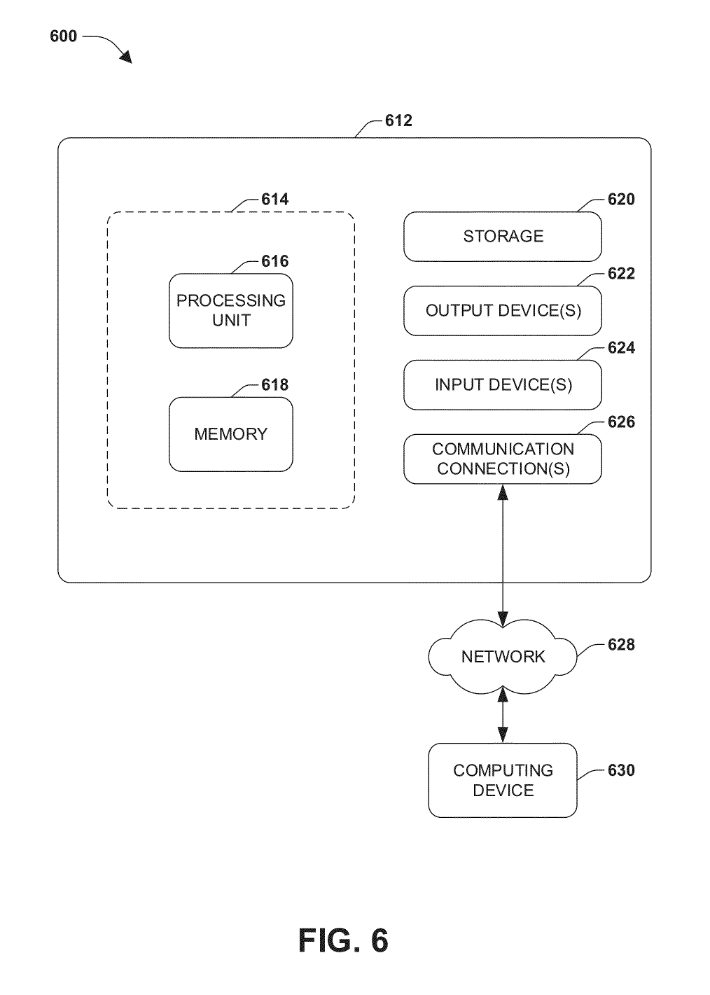

For one or more of the figures herein, one or more boundaries, such as boundary 614 of FIG. 6, for example, may be drawn with different heights, widths, perimeters, aspect ratios, shapes, etc. relative to one another merely for illustrative purposes, and are not necessarily drawn to scale. For example, because dashed or dotted lines may be used to represent different boundaries, if the dashed and dotted lines were drawn on top of one another they would not be distinguishable in the figures, and thus may be drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but may encompass a portion of one or more other components as well.

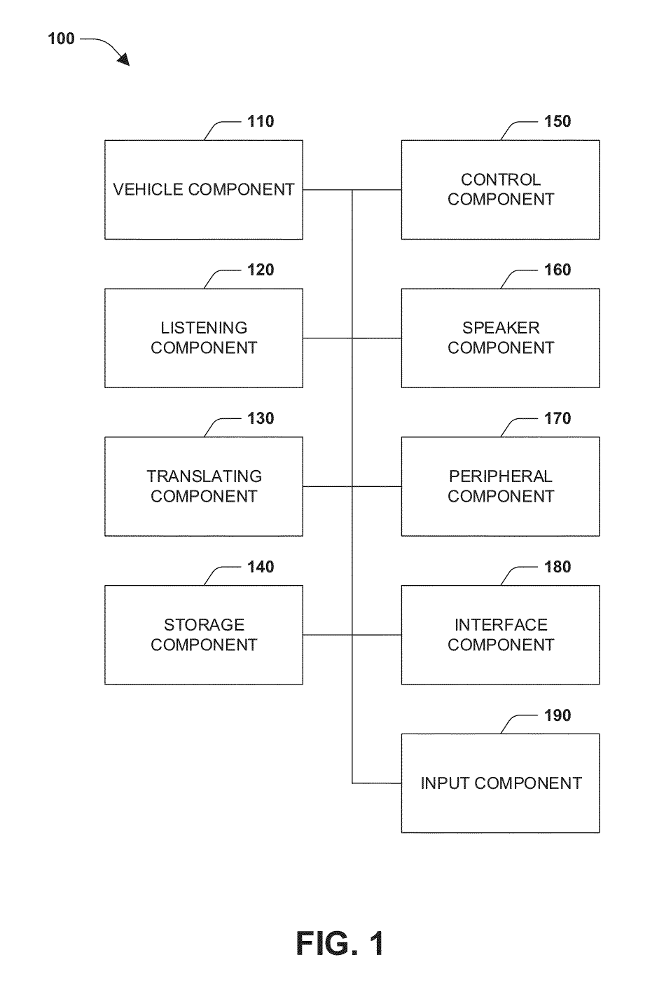

With reference to FIG. 1, a noise mitigation system 100 is depicted having various hardware components according to one or more embodiments. As used herein, noise mitigation may include actively monitoring ambient or background noise thereby generating a sound wave that can be used to reduce (or otherwise eliminate) perceivable background noise as perceived by a user. As will be understood, the system can employ noise mitigation technology and/or algorithms. Additionally, noise mitigation can be employed in most any seating devices and/or cabins including, but not limited to, construction, vehicle (e.g., passenger, long-haul), trucks, military, aircraft and the like.

The system 100 may include a vehicle component 110, a listening component 120, a translating component 130, a storage component 140, a speaker component 150, a control component 160, a peripheral component 170, an interface component 180, and an input component 190. The vehicle component 110 may include one or more locations where one or more listening components 120 may be embedded or incorporated therein. It will be appreciated, however, that the vehicle component does not necessarily have to be a part of the vehicle. For example, the vehicle component 110 may include a phone, tablet, heads-up device, etc.

Further, it will be appreciated the one or more listening components 120 may be implemented, embedded, or incorporated into one or more portions of the vehicle or the vehicle component 110 in a variety of ways. In one or more embodiments, one or more listening components 120 may be embedded within a seat (e.g., where the seat is a vehicle component 110). The seat may include one or more sub-components, such as one or more armrests, a backrest, a headrest, a seatbelt, padding, a neck rest, etc. As an example, a microphone, e.g. listening component 120 may be embedded in the seat or vehicle component 110. As another example, other listening components 120 may be incorporated with other portions of the vehicle or vehicle components 110, such as by embedding microphones in the steering wheel of the vehicle.

As mentioned, the listening component 120 may be implemented in a variety of ways, at one or more different positions, or embedded at one or more different locations or portions of the vehicle or vehicle component(s) 110. For example, one or more listening components 120 may be embedded within a vehicle component 110 which is a seat. In this way, one or more of the listening components 120 may monitor one or more noise sources or users or positioned in the seat. A plurality of listening components 120 may be scattered around a range of areas to ensure coverage of all noise appreciated in the vehicle component 110. The listening component 120 includes one or more microphones configured to record ambient noise or sound waves, preferably located to capture ambient noise from surrounding noise generators such as, but not limited to, an engine, other vehicles, road noise, and the like.

It will be appreciated that a listening component 120, as used herein, may include one or more devices the capture noise or sound waves which converts the captured noise into a signal which may be read (e.g., such as by an observer or an electronic device or instrument) and/or stored. In this way, one or more of the listening components 120 may receive one or more signals and transmit the one or more signals.

The translating component 130 may convert one or more signals from one or more of the listening components 120 into a storable format. For example, the translating component 130 may convert one or more of the signals into a format suitable for storage on the storage component 140. In one or more embodiments, the system 100 may utilize a communication channel or telematics channel to transmit (e.g., via the interface component 190) one or more of the signals from one or more of the listening components 120 to a server or external storage device (not shown). The translating component 130 may convert signals from the one or more listening components 120 to a format suitable for playback, storage on a storage component, and etc. The translating component 130 may compress the signals received from the listening component 120 for easier storage on the storage component 140. The storage component 140 may facilitate storage or storing one or more noise signals from the listening component 120.

The control component 150 controls the noise mitigation for output through the speaker component 160. The control component 150 receives the noise signal from the listening component 120 and/or the translating component 130 and/or the storage component 140. The control component 150 generates a noise cancellation signal that will mitigate the perceived noise in the vehicle component 110 e.g. in the cabin or at the seat. The control component 150 can utilize various noise cancellation techniques or algorithms. In one embodiment, the control component 150 generates a noise mitigation signal using phase shifting techniques.

In one embodiment, it is preferable to not cancel out all noise or specific noises and/or sounds from the ambient area. For example, a siren from a police car or ambulance is a noise that is important for the user to hear. The control component 150 generates a noise mitigation signal that is modified to not cancel, or alternatively to amplify, portions of received noise signals that are based at least in part on sound profiles of an audio library. Amplification can involve building a cancellation signal that includes anti-phase components of portions of the audio signal not associated with sound profiles of the audio library, but includes in-phase components of portions of the audio signal associated with sound profiles of the audio library. In one embodiment, the control component 150 determines that a received audio signal via the listening component 120 comprises portions based at least in part on the one or more sound profiles, a user, e.g., driver, passenger, etc. can be provided with an alert (e.g., audio, visual, vibratory, tactile, etc.) associated with a determined sound profile. In some embodiments, the audio library is stored on the storage component 140. In another embodiment, the audio library is stored on a cloud storage.

The control component 150 can be coupled to an audio library comprising one or more sound profiles (e.g., emergency vehicle sirens, telephone ring tones, etc.). Audio signals received by one or more primary listening components 120, e.g., upon which a cancellation signal can be determined, which can be internal to a vehicle cabin, etc., and/or one or more auxiliary listening components 120, e.g., which can be internal to and/or external to a vehicle cabin, etc., can be compared to the one or more sound profiles to determine if received audio signals comprise portions based at least in part on the one or more sound profiles, e.g., including Doppler shifted variations, such as from relative motion between a source of the sound profile and the subject innovation, damped variations, etc.

In one or more embodiments, the control component 150 facilitates noise cancellation or noise mitigation based on an activity in which a user, e.g. driver or an operator of a vehicle, is engaged. For example, the listening component 120 may detect if the user is conversing with another occupant of the vehicle component 110 and initiate noise cancellation during the conversation. In other embodiments, the magnitude or amount of reduction in noise may be based on the activity, a time of day, traffic around the vehicle, a location of the vehicle, etc. For example, in heavy traffic, noise cancellation may be reduced by a predetermined amount (e.g., a smaller amount) so that the driver or operator of the vehicle can hear approaching vehicles, etc. As another example, noise cancellation may be directed at one or more occupants of the vehicle based on whether the occupant is a driver or a passenger or whether the occupant is awake or sleeping. Here, noise cancellation may be enhanced for occupants who are not operating the vehicle or napping, for example. In one embodiment, two or more seats in a vehicle cabin have noise cancellation speaker components 160 with each seat having a distinct noise cancellation output that is controlled by the control component 150.

The control component 150 is coupled to one or more speaker components 160. The speaker component 160 can be audio devices, such as a vehicle sound system, one or more communication devices (e.g., radio, cell phone, etc.), etc. In some aspects, one or more audio signals from the one or more speaker components 160 can be identified and subtracted from a net audio signal received by the one or more listening components 120 to generate a modified cancellation signal that is antiphase to the net audio signal after subtraction of the one or more identified audio signals.

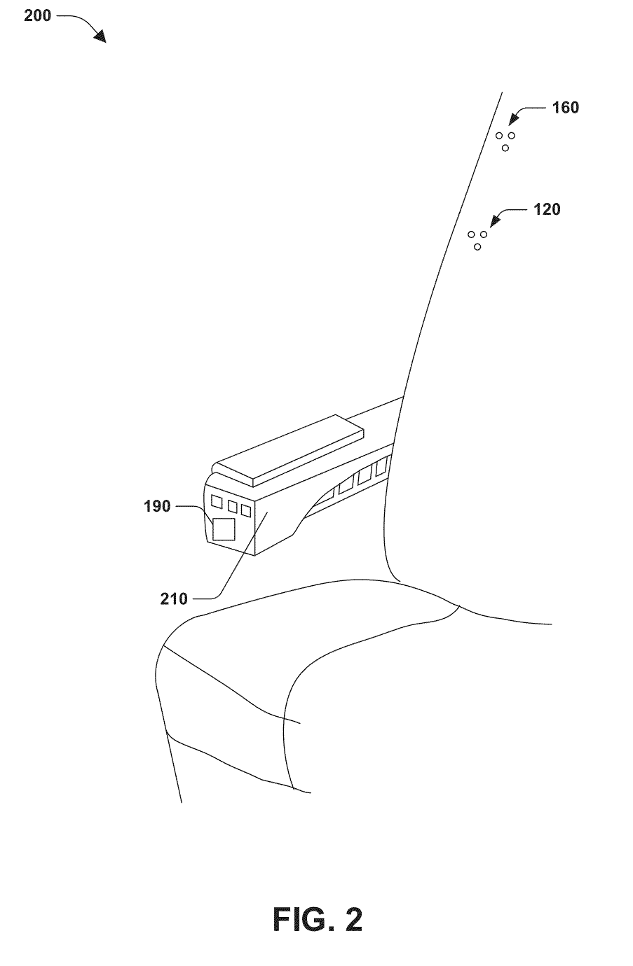

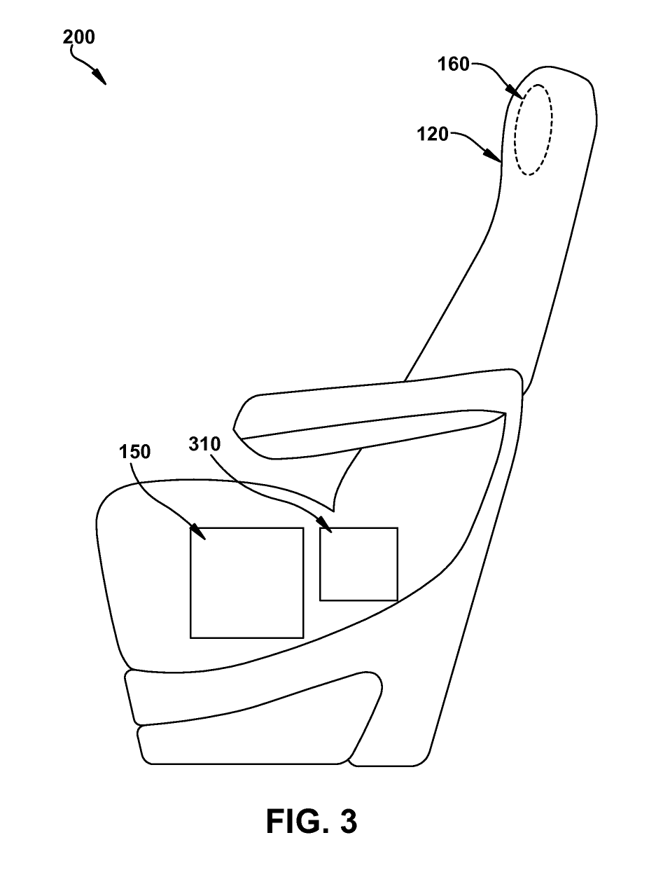

The speaker component 160, i.e. sound output devices, are disposed or positioned within the vehicle component 110. With reference to FIGS. 2 and 3, the speaker component 160 is disposed or positioned in a seating unit 200 so as to provide a user, e.g., operator/occupant, an effect of mitigating unwanted noise. In one embodiment, multiple speaker components 160 are employed which enhance the noise cancellation effect via the control module 150 and associated logic. In certain embodiments, the listening component 120 can be positioned within a seating device so as to enhance noise cancellation effect.

Further, it will be appreciated the one or more speaker components 160 may be implemented, embedded, or incorporated into one or more portions of the vehicle or the vehicle component 110 in a variety of ways. In one or more embodiments, one or more speaker components 120 may be embedded within a seat (e.g., where the seat is a vehicle component 110). The seat may include one or more sub-components, such as one or more armrests, a backrest, a headrest, a seatbelt, padding, a neck rest, etc. As an example, a speaker component 160 may be embedded in the seat or vehicle component 110. As another example, other speaker components 150 may be incorporated with other portions of the vehicle or vehicle components 110, such as by embedding speakers in the steering wheel of the vehicle or through a vehicle audio/radio system.

The control component 150 can interface with other devices used by the user via the peripheral component 170. For example, the control component 150 can pair noise cancellation with one or more modes on a mobile device, e.g., a sleep mode or do not disturb mode on a mobile device. When noise cancellation is activated, a mobile device via the peripheral component 170 may automatically be put in a do not disturb mode, for example.

The control component 150 can activate other aspects of the vehicle component 110 via the interface component 180. For example, the control component 150 can activate features associated with safety. For example, when a user engages in a noise cancellation mode, the control component 150 may heighten awareness of blind spots around the vehicle component by flashing one or more lights or LEDs on a display for the operator when other vehicles are approaching, etc. The control component 150 can also alert the user to take appropriate action when the listening component 120 detects emergency sirens.

The interface component 180 may communicatively couple the system 100 with a mobile device, one or more servers, external hardware, a controller area network (CAN) of a vehicle, etc. In one or more embodiments, the interface component 180 may include a docking station which enables a mobile device to be communicatively coupled (e.g., wirelessly or via a hard wire, such as Universal Serial Bus or USB) to the system 100 of FIG. 1.

In one or more embodiment, the input component 190 may enable accepting of one or more inputs from one or more users. In response to one or more of the inputs, a display or peripheral component 170 may cycle through one or more display modes having different sound profiles or different display information. The input component 190 may be implemented as software or hardware, as buttons, keys, a keyboard, include a microphone, or be received from the mobile device when a mobile device is docked with the interface component 180. In one embodiment, with continuing reference to FIG. 2, the input component 190 can be disposed within an armrest 210 of a seat 200 inside the vehicle component to provide easy access for a user to provide input into the noise cancellation feature. The input component of the example includes buttons on the armrest to control or change settings of the system including sound profiles, on/off function, a display via the peripheral component 170, a mobile device via the interface component 180, and the like.

The interface component 180 may enable connectivity with one or more mobile devices. For example, a mobile device may have an application which enables a user to interact with one or more aspects of the system 100 of FIG. 1. The user may setup customizable alerts based on different conditions. The mobile device may have an application or interface for reviewing one or more of the sound profiles in the audio library. The interface component 180 may communicatively couple the system 100 or the storage component 140 to one or more devices or one or more servers and facilitate upload or transfer of sound profiles or noise cancellation parameter data to one or more of the devices or one or more of the servers. It will be appreciated that the transfer of such data may be done wirelessly, via telematics, etc.

With continuing reference to FIG. 3, the control component 150 can be disposed within the seat 200 or any place in the vehicle component 110. Further, a power component 310 can be disposed in the seat 200 which provides power to the components via electrical connection or power bus.

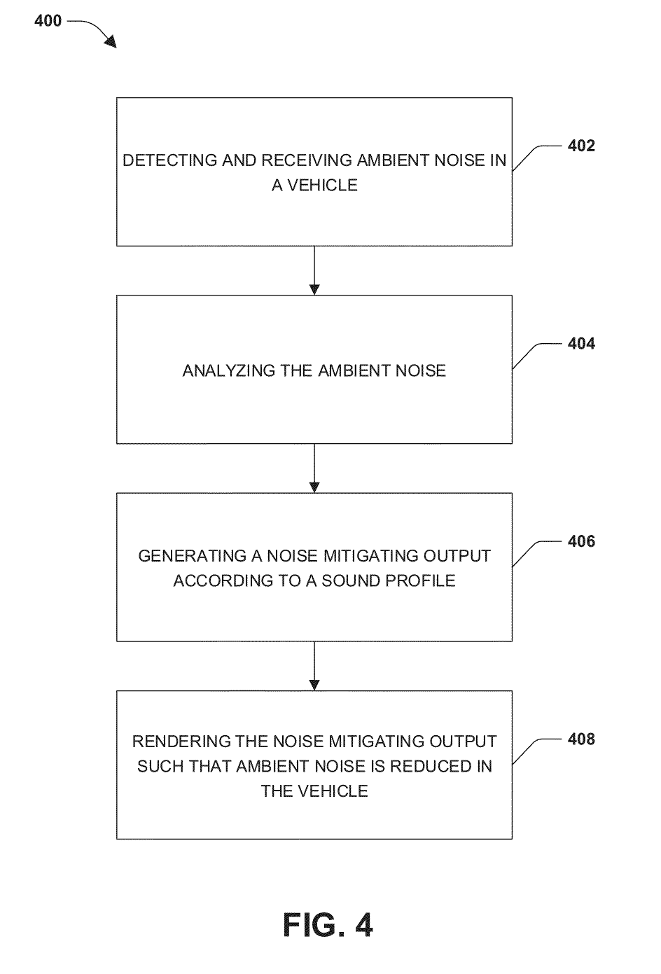

With reference to FIG. 4, a flowchart for noise mitigation 400 is illustrated. At a step 402, ambient noise in a vehicle is detected and received for processing at one or more processors. The ambient noise is detected by one or more listening components 120 or microphones disposed around a vehicle to detecting the ambient noise. At a step 404, the ambient noise from the vehicle is analyzed using one or more processors. At a step 406, a noise mitigating output is generated using one or more processors. The noise mitigating output is generated according to a noise cancellation and/or mitigation algorithm. At a step 408, the noise mitigating output is rendered inside the vehicle such that the noise mitigating output destructively interferes with the ambient noise such that the overall perceived noise by the user inside the vehicle is reduced.

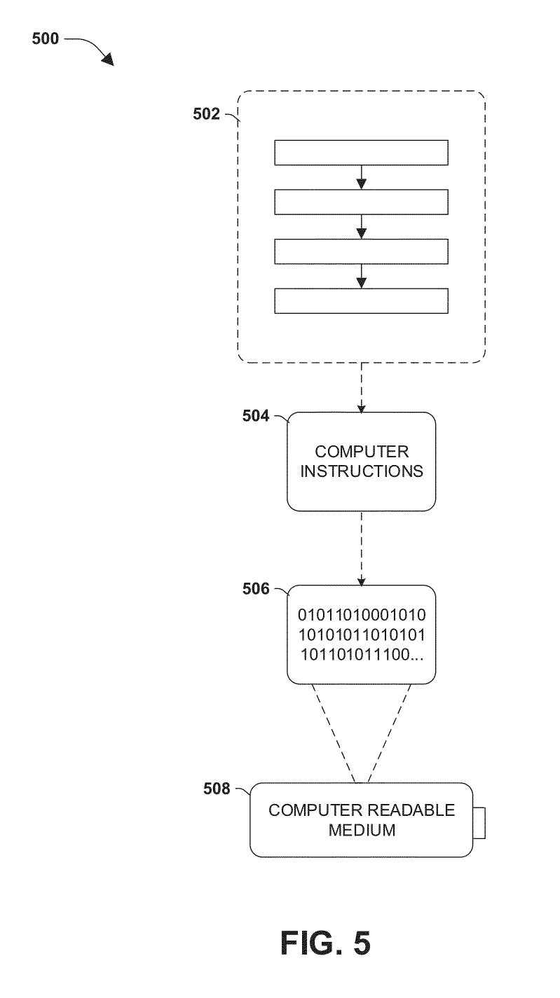

Still another embodiment involves a computer-readable medium including processor-executable instructions configured to implement one or more embodiments of the techniques presented herein. An embodiment of a computer-readable medium or a computer-readable device devised in these ways is illustrated in FIG. 5, wherein an implementation 500 includes a computer-readable medium 508, such as a CD-R, DVD-R, flash drive, a platter of a hard disk drive, etc., on which is encoded computer-readable data 506. This computer-readable data 506, such as binary data including a plurality of zero's and one's as shown in 506, in turn includes a set of computer instructions 504 configured to operate according to one or more of the principles set forth herein. In one such embodiment 500, the processor-executable computer instructions 504 are configured to perform a method 502, such as the method 400 of FIG. 4. In another embodiment, the processor-executable instructions 504 are configured to implement a system, such as the system 100 of FIG. 1. Many such computer-readable media are devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 6 and the following discussion provide a description of a suitable computing environment to implement embodiments of one or more of the provisions set forth herein. The operating environment of FIG. 6 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 6 illustrates a system 600 including a computing device 612 configured to implement one or more embodiments provided herein. In one configuration, computing device 612 includes at least one processing unit 616 and memory 618. Depending on the exact configuration and type of computing device, memory 618 may be volatile, such as RAM, non-volatile, such as ROM, flash memory, etc., or a combination of the two. This configuration is illustrated in FIG. 6 by dashed line 614.

In other embodiments, device 612 includes additional features or functionality. For example, device 612 may include additional storage such as removable storage or non-removable storage, including, but not limited to, magnetic storage, optical storage, etc. Such additional storage is illustrated in FIG. 6 by storage 620. In one or more embodiments, computer readable instructions to implement one or more embodiments provided herein are in storage 620. Storage 620 may store other computer readable instructions to implement an operating system, an application program, etc. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by device 612. Any such computer storage media is part of device 612.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 612 includes input device(s) 624 such as keyboard, mouse, pen, voice input device, touch input device, infrared cameras, video input devices, or any other input device. Output device(s) 622 such as one or more displays, speakers, printers, or any other output device may be included with device 612. Input device(s) 624 and output device(s) 622 may be connected to device 612 via a wired connection, wireless connection, or any combination thereof. In one or more embodiments, an input device or an output device from another computing device may be used as input device(s) 624 or output device(s) 622 for computing device 612. Device 612 may include communication connection(s) 626 to facilitate communications with one or more other devices.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A system that facilitates noise mitigation, comprising:
at least one listening component that samples ambient noise;
a control module that receives and analyzes a noise signal from the listening component and generates an output based at least in part upon the analysis; and
at least one speaker component that renders the output, wherein the at least one speaker is positioned within a seating apparatus of a vehicle component.

2. The system of claim 1, wherein the output is a noise cancelling signal that cancels at least a portion of ambient noise observed by the listening component.

3. The system of claim 1, further comprising additional listening components that sample ambient noise and thereby input to the control unit to generate the output.

4. The system of claim 1, wherein the generated output is a phase shifted audio signal that destructively interferes with the ambient noise sampled by the listening component.

5. The system of claim 1, further comprising:
a storage component comprising sound profiles in an audio library, wherein the sound profiles.

6. The system of claim 5, wherein the sound profiles dictate noise sources to cancel.

7. The system of claim 5, wherein the sound profiles dictate noise sources to amplify.

8. The system of claim 5, wherein the control component accesses the sound profiles and generates the output according to a selected sound profile.

9. The system of claim 1, wherein the control component generates the output according to a determined activity in which a user is engaged.

10. The system of claim 1, wherein the control component varies the level of noise mitigation in the generated output for a user that is not operating the vehicle component.

11. The system of claim 1, wherein the control component activates safety features of the vehicle component via an interface component and a peripheral component.

12. The system of claim 1, further comprising a power source that provides power to the components of the system.

13. A method of mitigating noise, comprising:
receiving an audio signal input of detected ambient noise;
analyzing the audio signal input;
generating a noise mitigating output based on the analyzed audio signal input; and
rendering the noise mitigating output such that detected ambient noise is reduced.

14. The method according to claim 13, wherein the generated output is a phase shifted audio signal that destructively interferes with the ambient noise.

15. The method according to claim 13, further comprising:
accessing one or more sound profiles that dictate at least one of the level of ambient noise mitigation, noises to mitigate, and/or noises to amplify.

16. The method according to claim 13, further comprising:
determining at least part of the ambient noise is generated from an emergency vehicle; and
amplifying the part of the ambient noise that is determined to be from the emergency vehicle.

17. The method of claim 13, further comprising:
determining the activity in which a user is engaged; and
varying the generated output according to the determined activity.

18. The method of claim 16, wherein the determining step further includes:
interfacing with a user mobile device.

19. The method of claim 16, further comprising:
interfacing with a vehicle control system of a vehicle; and
activating safety features based on the analyzed audio input.

20. A computer readable medium having instructions for controlling one or more processors configured to:
detect ambient noise inside and around a vehicle cabin;
convert the ambient noise into a digital audio signal;
analyze the digital audio signal for noise mitigation;
access a sound profile that details settings for noise mitigation based on stored criteria;
generate a cancellation wave signal according to the sound profile and the analyzed digital audio signal; and
play the cancellation wave signal in the vehicle cabin to interfere with the ambient noise.
